(19) United States
(12) Patent Application Publication
(10) Pub. No.: US 2018/0278795 A1
(43) Pub. Date: Sep. 27, 2018

(54) SYSTEM AND METHOD OF GENERATING BARCODES ON SCANNED DOCUMENTS

(71) Applicants: Kabushiki Kaisha Toshiba, Minato-ku (JP); Toshiba TEC Kabushiki Kaisha, Shinagawa-ku (JP)

(72) Inventor: Jia ZHANG, Irvine, CA (US)

(21) Appl. No.: 15/466,457

(22) Filed: Mar. 22, 2017

(51) Int. Cl. H04N 1/32; H04N 1/00

(52) U.S. Cl. CPC H04N 1/32133; H04N 1/0044; H04N 2201/0081; H04N 2201/0094; H04N 1/00331

(57) ABSTRACT

A system and method for adding a barcode to an electronic document includes a multifunction peripheral having a user interface for accepting commands and data from a user, a scan engine that scans a tangible document into an electronic document, and a processor that generates a barcode from barcode identifying data. The user can enter a document identifier via a user interface as the barcode identifying data. The user can select an area of the electronic document via the user interface and the processor can extract the barcode identifying data using optical character recognition of the selected area. A user can enter barcode position data via the user interface and the processor can generate a barcoded electronic document in accordance with the barcode position data. The barcoded electronic document can be forwarded to the user via a network interface associated with the multifunction peripheral.

### TECHNICAL FIELD

This application relates generally to generating identifying indicia that are inserted into scanned documents. The application relates more particularly to generating a barcode that is added to the electronic version of a scanned document.

### SUMMARY

In an example embodiment, a system and method for adding a barcode to an electronic document includes a multifunction peripheral having a user interface for accepting user input such as data and commands, a scan engine configure to scan a tangible document into an electronic document, and a processor configured to generate a barcode from barcode identifying data. A user can enter a document identifier via a user interface as the barcode identifying data. The user can select an area of the electronic document via the user interface and the processor can extract the barcode identifying data using optical character recognition of the selected area. A user can enter barcode position data via the user interface and the processor can generate a barcoded electronic document in accordance with the barcode position data. The barcoded electronic document can be forwarded to the user via a network interface associated with the multifunction peripheral.

In another example embodiment, a multifunction peripheral includes a scanner, a user interface, and a controller. The scanner scans a physical or tangible document into an electronic form of the document, or scanned document. The user interface includes a display for displaying a preview of the scanned document, and a user input for accepting user commands associated with obtaining or entering barcode data for the scanned document. The controller includes a processor and memory, and determines the barcode data based on the user commands, such as a user entry of alphanumeric characters, or the selection of a selected area of the preview, from which the processor can extract the barcode data based on performing optical character recognition of alphanumeric characters in the selected area. The controller generates a barcode based on the barcode data, positions the barcode onto the scanned document, and outputs a scanned document that has the barcode on one or more pages of the document. The user input can be configured to accept user commands, such as the entry of an x,y coordinate pair, to position the barcode as desired by the user on the scanned document. The user input can be configured to accept user commands for determining which pages of the document the barcode are to include the barcode. The scanned document with the barcode can be output to a printer or print engine, or forwarded to a user as an electronic document, for example via email.

### BACKGROUND

Document processing devices include printers, copiers, scanners and e-mail gateways. More recently, devices employing two or more of these functions are found in office environments. These devices are referred to as multifunction peripherals (MFPs) or multifunction devices (MFDs). As used herein, MFP means any of the forgoing. Given the expense in obtaining and maintaining MFPs, MFPs are frequently shared by users and monitored by technicians via a data network for example using Simple Network Management Protocol (SNMP). When a user scans a document on an MFP, the MFP makes the scanned document available to the user, for example by forwarding the scanned document directly to the user via email, or by storing the document in a network server that the user can access.

Barcodes are machine-readable representations of data that can assist in identifying items, such as a product, a shipped item, or a document. Example barcodes include Universal Product Codes or UPCs, and Quick Response or QR codes, as well as a myriad of other linear and two-dimensional bar codes.

To add a barcode to an item, such as a document, a label or sticker is usually separately printed, using specialized software and often a dedicated purpose printer. To add a barcode to the electronic version of a scanned document, a user would ordinarily be required to first scan a document on an MFP and then return to their desktop computer, retrieve the electronic version of the document, and use specialized software to attach a barcode to the document. Many users may not have the necessary software installed on their computers, or the technical proficiency to complete the necessary operations available via the software.

### BRIEF DESCRIPTION OF THE DRAWINGS

FIG. 1 is a diagram of an example system for generating barcodes on scanned documents according to an embodiment of the disclosure.

FIG. 2 is a block diagram of an example of components of a multifunction peripheral according to an embodiment of the disclosure.

FIG. 3 is a block diagram of an example of components of a computing device according to an embodiment of the disclosure.

FIG. 4 is a diagram of example software operations of a system for generating barcodes on scanned documents according to an embodiment of the disclosure.

FIG. 5 is a flowchart of example operations of a system for generating barcodes on scanned documents according to an embodiment of the disclosure.

FIG. 6 is a screenshot of a display for defining barcode data according to an embodiment of the disclosure.

FIG. 7 is a screenshot of an example scanned document from which barcode data can be obtained using optical character recognition (OCR) according to an embodiment of the disclosure.

FIG. 8 is a screenshot of a display for defining the location for placing barcode data on a scanned document according to an embodiment of the disclosure.

FIG. 9 is a screenshot of a display of a scanned document with a barcode according to an embodiment of the disclosure.

### DETAILED DESCRIPTION

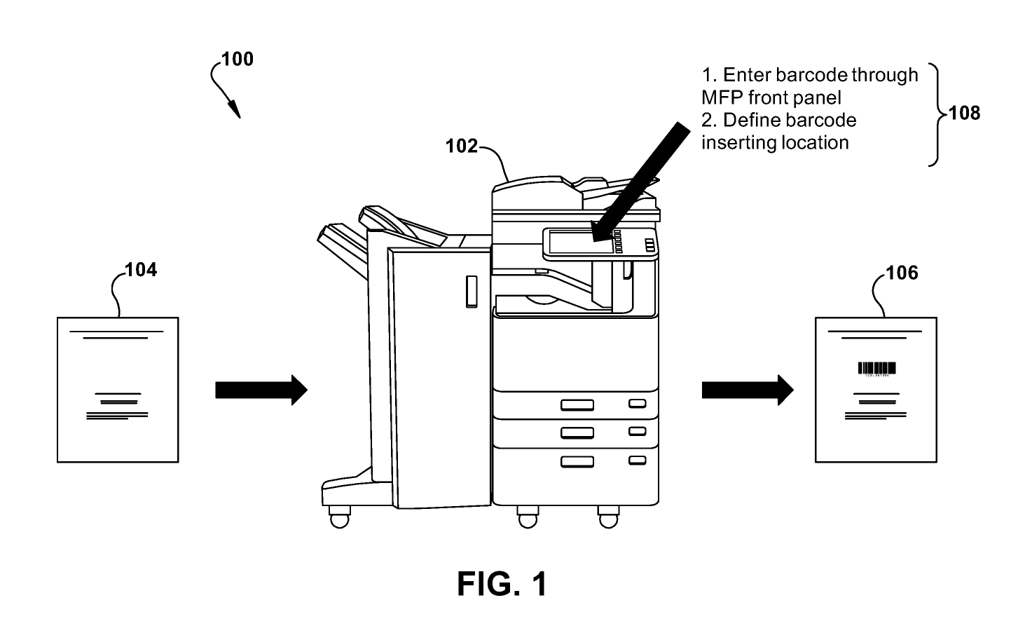

Turning to FIG. 1, illustrated is example embodiment of a system 100 for generating barcodes on scanned documents. The system 100 includes one or more multifunction peripherals, such as MFP 102, that are configured to scan user documents, such as document 104. To generate a barcode on a scanned document, the user first scans the physical document 104 on the MFP, and then enters instructions 108 on a display panel of the MFP 102. Example instructions can include entering the barcode via a touchscreen interface of the MFP 102 and defining where to place the barcode. The MFP then forwards the scanned document with the barcode 106 to the user. Other suitable instructions and display interfaces are described below in greater details.

Advantageously, a user can add a barcode to any scanned document 106 at the MFP 102 at the time that the physical document 104 is scanned. The system 100 alleviates the necessity for the user to either add a printed bar code to the document 104 prior to scanning, or return to their desktop computer and use specialized software to insert a barcode into the scanned document 106.

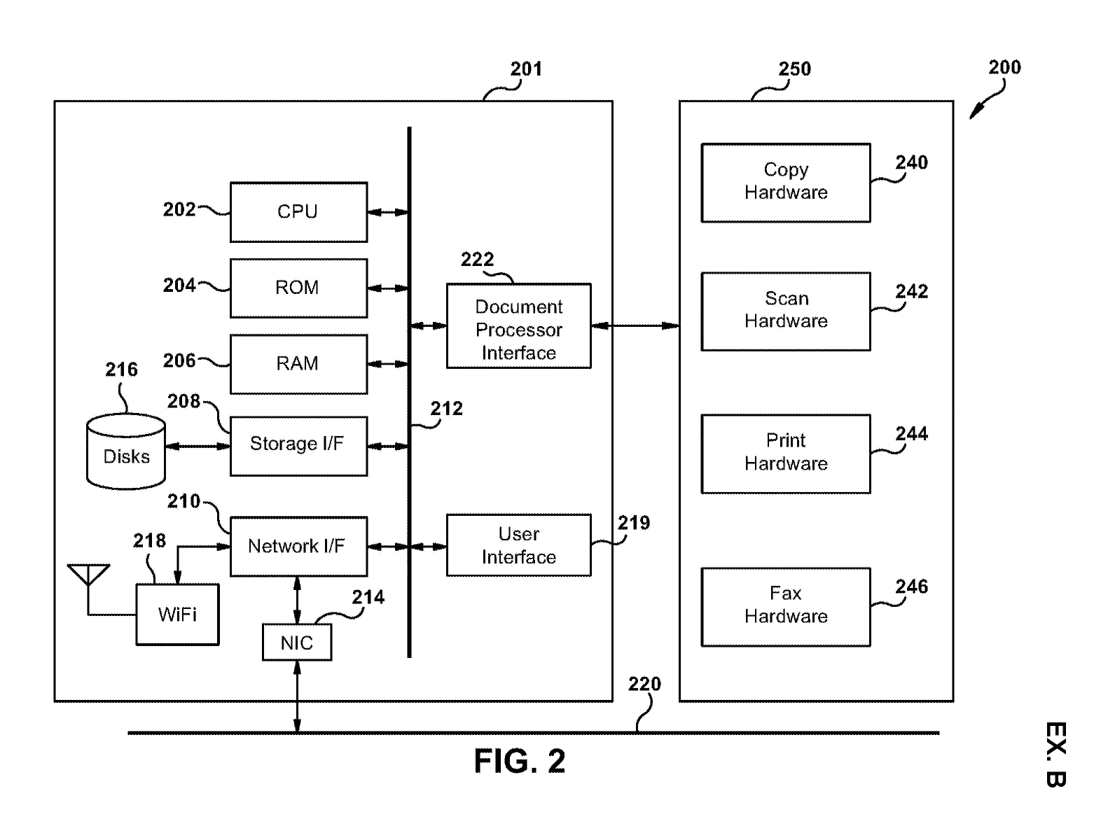

Turning now to FIG. 2, illustrated are functional components 200 suitably comprising a multifunctional peripheral such as MFP 102 of FIG. 1. Included is controller 201 comprised of one or more processors, such as that illustrated by processor 202. Each processor is suitably associated with non-volatile memory such as ROM 204, and random access memory (RAM) 206, via a data bus 212.

Processor 202 is also in data communication with a storage interface 208 for reading or writing to a storage 216, suitably comprised of a hard disk, optical disk, solid-state disk, cloud-based storage, or any other suitable data storage as will be appreciated by one of ordinary skill in the art.

Processor 202 is also in data communication with a network interface 210 which provides an interface to a network interface controller (NIC) 214, which in turn provides a data path to any suitable wired or physical network connection 220, or to a wireless data connection via wireless network interface 218. Example wireless connections include cellular, Wi-Fi, Bluetooth, NFC, wireless universal serial bus (wireless USB), satellite, and the like. Example wired interfaces include Ethernet, USB, IEEE 1394 (FireWire), Apple Lightning, telephone line, or the like.

Processor 202 can also be in data communication with any suitable user input/output (I/O) interface 219 which provides data communication with user peripherals, such as displays, keyboards, mice, track balls, touch screens, or the like. Hardware monitor suitably provides device event data, working in concert with suitably monitoring systems. By way of further example, monitoring systems may include page counters, sensor output, such as consumable level sensors, temperature sensors, power quality sensors, device error sensors, door open sensors, and the like. Data is suitably stored in one or more device logs, such as in storage 216.

Also in data communication with data bus 212 is a document processor interface 222 suitable for data communication with MFP functional units 250. In the illustrated example, these units include copy hardware 240, scan hardware 242, print hardware 244 and fax hardware 246 which together comprise MFP functional hardware 250. It will be understood that functional units are suitably comprised of intelligent units, including any suitable hardware or software platform.

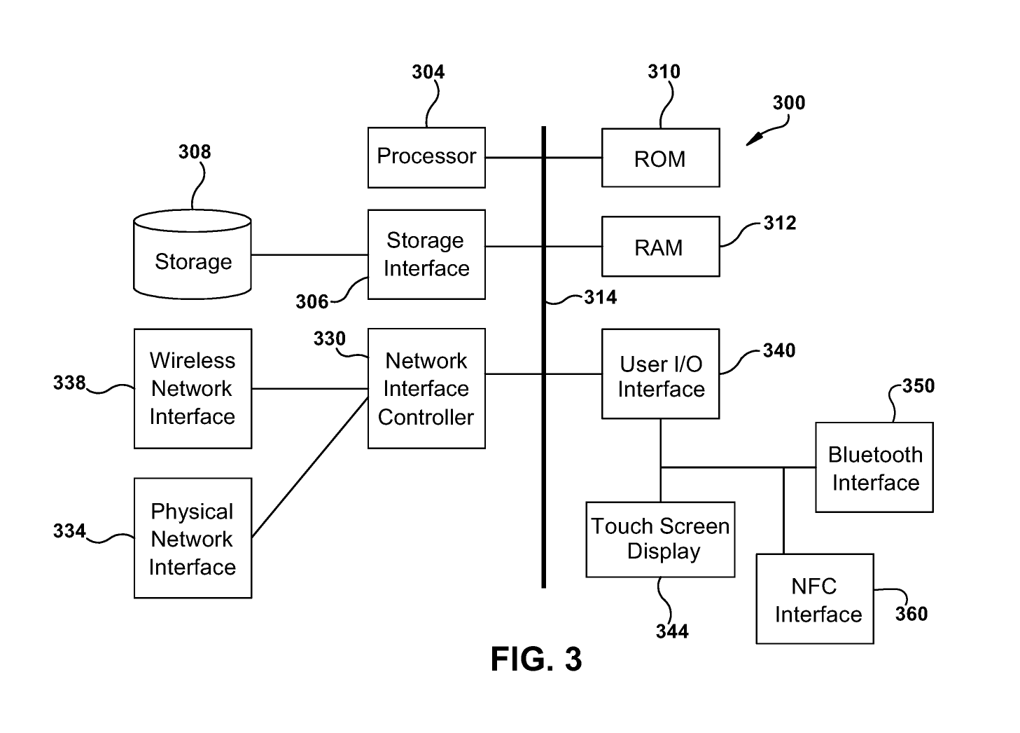

Turning now to FIG. 3, illustrated is an example embodiment 300 of a digital computing device which architecture is suitably implemented in a document processing device such as an MFP controller. Included are one or more processors, such as that illustrated by processor 304. Each processor is suitably associated with non-volatile memory, such as read only memory (ROM) 310 and random access memory (RAM) 312, via a data bus 314.

Processor 304 is also in data communication with a storage interface 316 for reading or writing to a data storage system 318, suitably comprised of a hard disk, optical disk, solid-state disk, or any other suitable data storage as will be appreciated by one of ordinary skill in the art.

Processor 304 is also in data communication with a network interface controller (NIC) 330, which provides a data path to any suitable wired or physical network connection via physical network interface 334, or to any suitable wireless data connection via wireless network interface 338, such as one or more of the networks detailed above.

Processor 304 is also in data communication with a user input/output (I/O) interface 340 which provides data communication with optional user peripherals, such as a display 344, a keyboard 350, a mouse 360 or any other interface, such as track balls, touchscreens, or the like. It will be understood that functional units are suitably comprised of intelligent units, including any suitable hardware or software platform.

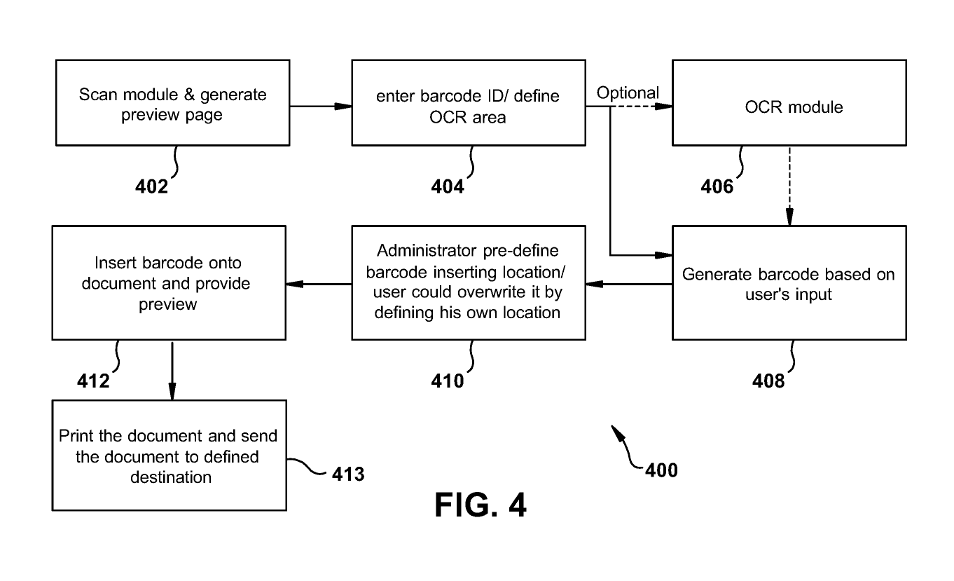

FIG. 4 illustrates example software operations of a system 400 for generating barcodes on scanned documents. The system 400 includes a scan module 402 for scanning the physical user document and generating a display page. A barcode entry module 404 allows a user to manually enter a barcode data or optionally define an area of the document for obtaining barcode data using optical character recognition (OCR). An optional OCR module 406 performs OCR to recognize characters in an area of the document to use as barcode data. A barcode generation module 408 generates a suitable barcode using the barcode data entered by the user via the barcode entry module or the barcode data determined by the OCR module 406. A barcode positioning module 410 determines a suitable area, or position, in a scanned document to place the barcode. The position can be pre-defined by an administrator or positioned manually y the user. A barcode preview module 412 displays a digital representation of the scanned document with the barcode for the user to review and approve. A finishing module 413 finalizes the scanned document with barcode and output the document, for example by forwarding the scanned document with barcode to the user or by allowing the user to reprint the document with the barcode.

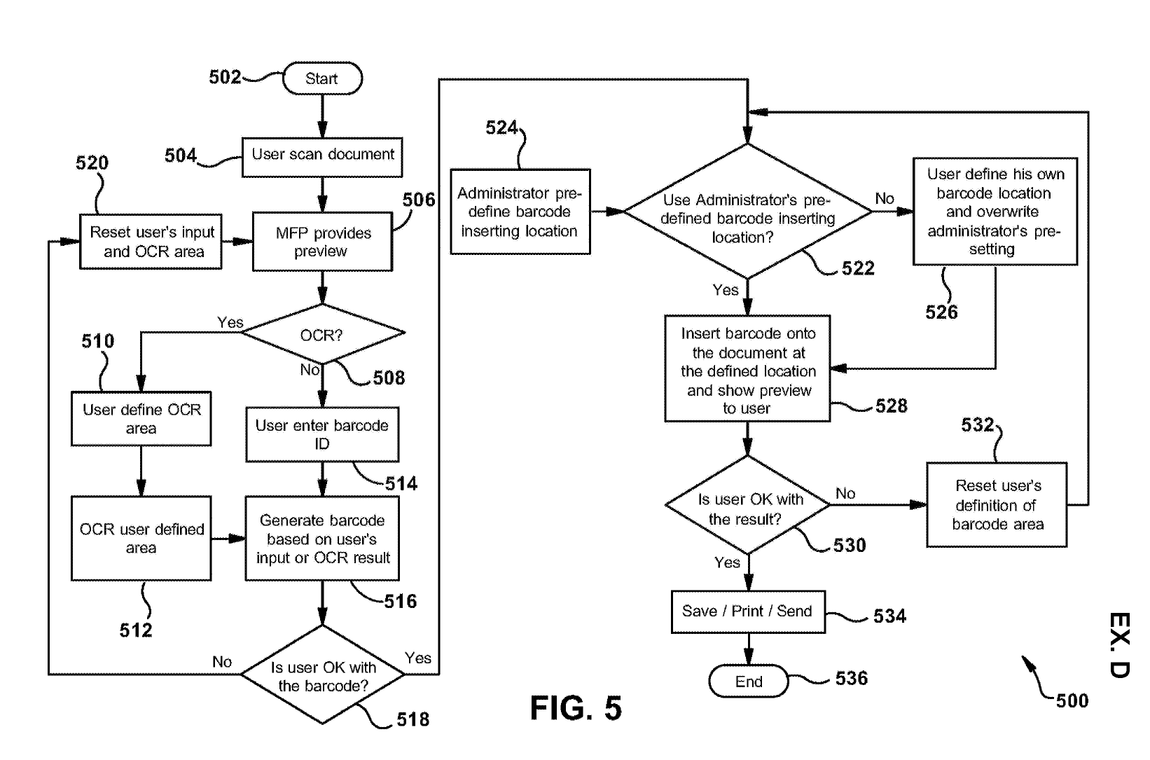

FIG. 5 illustrates example operations of a system for generating barcodes on scanned documents 500. Processing begins at start block 502 and proceeds to block 504. At block 504, a user scans a document on an MFP. Operation continues to block 506. At block 506, the MFP provides a preview of the scanned document. Operation continues to decision block 508. If the user desires to use OCR to capture barcode data, then processing continues to block 510 where the user defines the area to be OCRed, block 512 where the user defined area is OCRed, and block 516 where the barcode is generated. If the user does not use OCR, the processing continues to block 514 where the user manually enters barcode data, and processing proceeds to block 516 where the barcode is generated. Once the barcode is generated, processing continues to decision block 518. In decision block 518, if the user does not approve of the barcode, then processing continues to block 520 where the user's input or OCR are reset and processing returns to block 506. If the user approves of the barcode, then processing continues to decision block 522. In decision block 522, if the user approves using an administrator's pre-defined barcode insertion position 524 for the scanned document, then processing continues to block 528, otherwise processing continues to block 526 where a user can define the insertion position for the barcode in the scanned document, after which processing continues to block 528. In block 528 the barcode is inserted into the document at the insertion position and the user can view a preview of the scanned document with barcode. Processing continues to decision block 530. In decision block 530, if the use is not satisfied with the scanned document with barcode, then processing continues to block 532 where the barcode insertion position is reset, and processing returns to decision block 522. If the user accepts the scanned document with barcode, then processing continues to block 534 where the document can be saved, printed, and/or sent to the user, and processing terminates at end block 536.

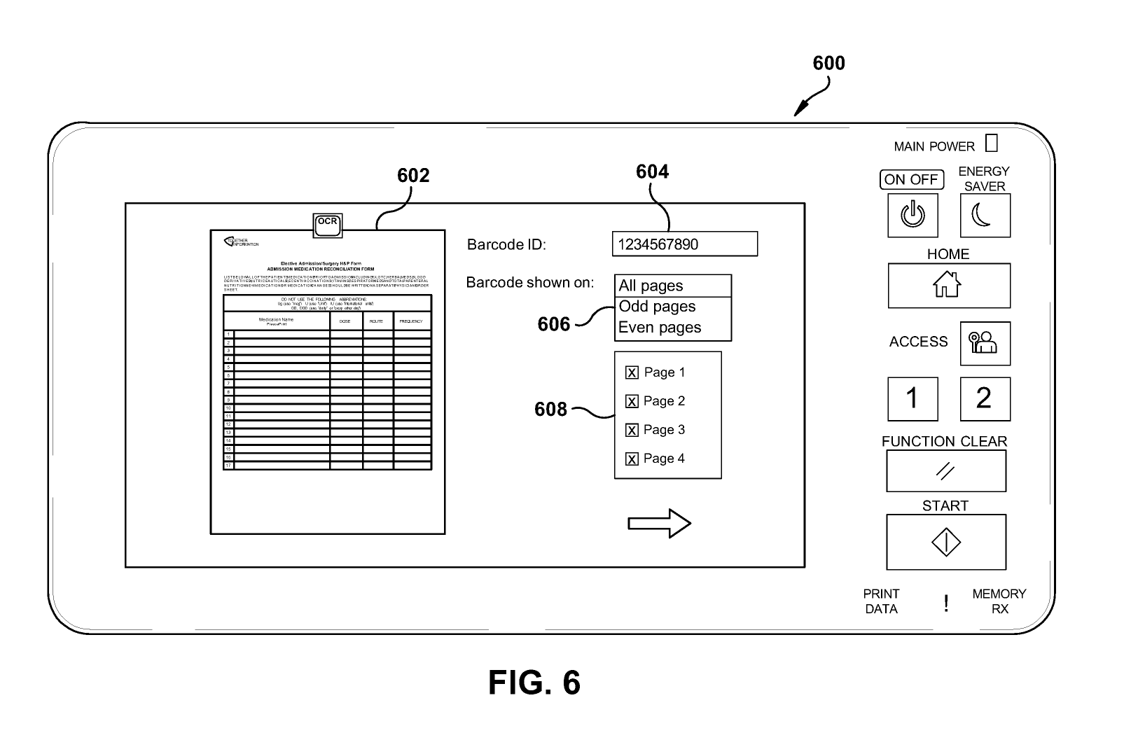

FIG. 6 illustrates an example display screen 600 on an MFP for entering barcode data. The display screen displays a preview 602 of the scanned document. A user can manually enter barcode data in a text entry box 604. Using a page selection drop-down list 606, the user can define whether the barcode is to be inserted on all pages, or just odd or even pages of the scanned document. A manual page selection list 608 allows the user to manually select which pages should include the barcode.

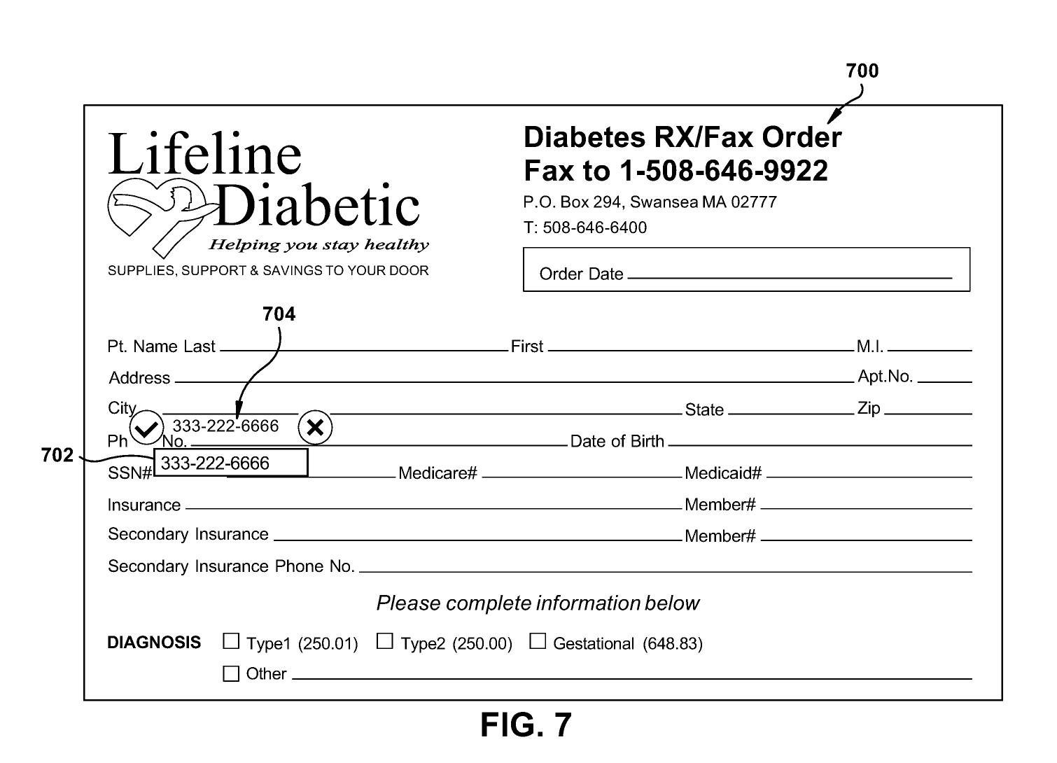

FIG. 7 illustrates using OCR to obtain barcode data from the scanned document on an example display screen 700. By selecting the preview of a scanned document, such as preview 602 of FIG. 6, the user can enlarge a portion of the scanned document that is previewed on the display screen of the MFP. The user selects an OCR scan area 702 of the scanned document. OCR is used to recognize the characters in the OCR scan area 702. An OCR result 704 can be displayed that allows the user to accept or rejection the proposed OCR result 704.

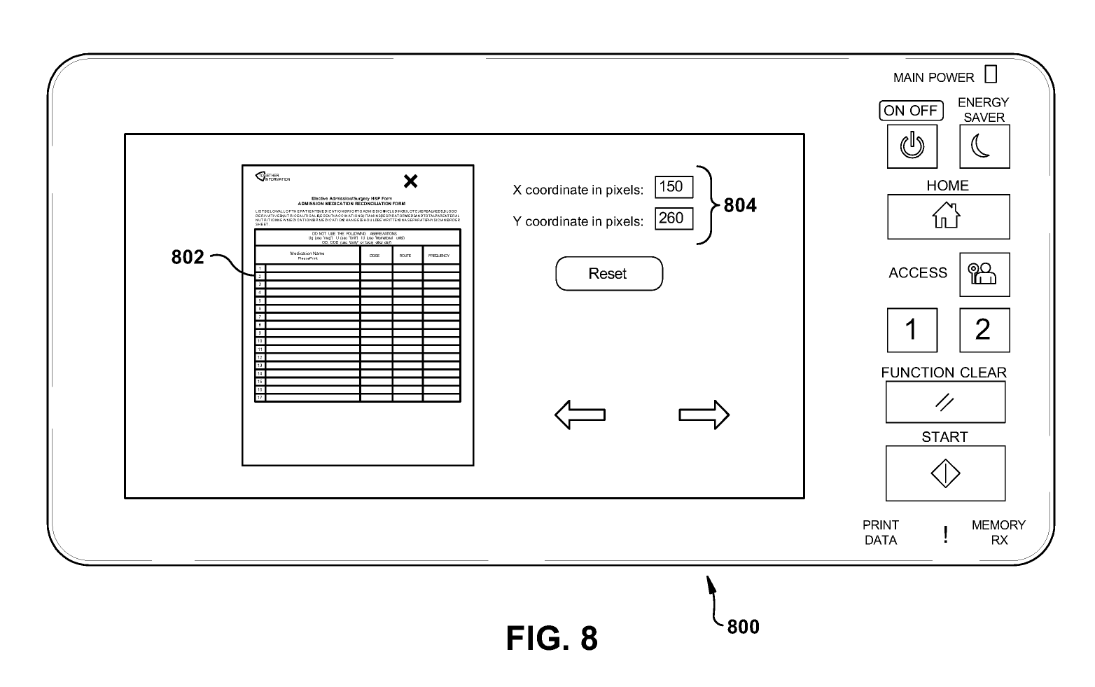

FIG. 8 illustrates an example display screen 800 for defining the location of the barcode. A predefined location, for example a location predefined by an administrator, can be displayed in coordinate boxes 804. The display screen 800 can display an indicator of the placement of the barcode on the preview of the scanned document 802, for example by showing an “x” as illustrated, or by showing a box, or a barcode, among other possible display indicators. The user can manually reposition the placement of the barcode on the preview of the scanned document 802, for example by entering data into the coordinate boxes 804, or by dragging the “x” to the desired position on the preview of the scanned document 802.

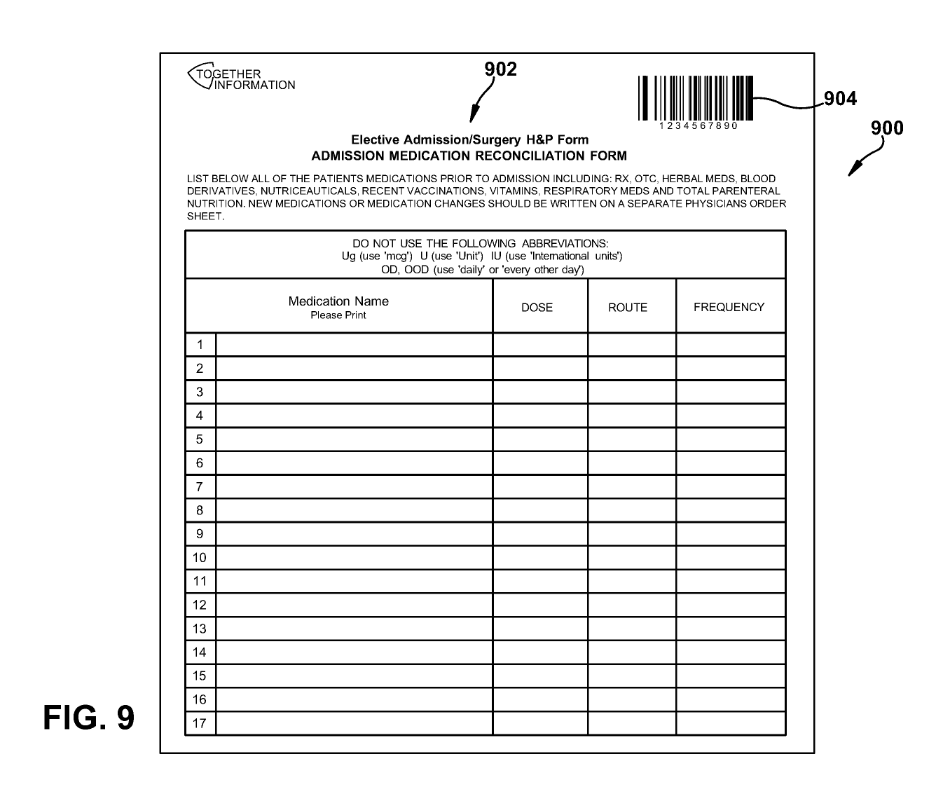

FIG. 9 illustrates an example display screen 900 for previewing the scanned document 902 with the barcode 904. If the user is satisfied with the result, the user can save, print, or send the result using suitable functions of the MFP. If the user is not satisfied with the result, the user can return to previously described display screen and make the desired corrections.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the spirit and scope of the inventions.

1. A multifunction peripheral comprising:
a scanner configured to scan a physical document comprising an information record associated with an identified person into electronic form as a scanned document;
a user interface including
a display configured to display a preview of the scanned document, and
a user input configured to accept user commands associated with barcode data for the scanned document, wherein the user commands include a user selection of a selected area of the displayed preview of the scanned document corresponding to an identity of the person; and
a controller including a processor and associated memory configured to
determine barcode data based at least in part on the user commands and at least in part on optical character recognition of one or more alphanumeric characters in the selected area,
generate a barcode identifying the person from the barcode data,
position the barcode onto the scanned document, and
output the scanned document with the barcode.

2. The multifunction peripheral of claim 1 wherein the user commands include a user entry of one or more alphanumeric characters, and wherein the barcode data includes the alphanumeric characters.

3. (canceled)

4. The multifunction peripheral of claim 1 wherein the processor is further configured to generate a preview of the scanned document with the barcode, and wherein the display is configured to display the preview of the scanned document with the barcode.

5. The multifunction peripheral of claim 4 wherein the user input is further configured to accept user commands associated with positioning the barcode on the scanned document, and wherein the processor positions the barcode onto the scanned document based at least in part on the user commands associated with positioning the barcode.

6. The multifunction peripheral of claim 5 wherein the position is associated with at least one x, y coordinate pair.

7. The multifunction peripheral of 5 wherein the position is based at least in part upon a user page input selected from the group consisting of all pages, only even pages, only odd pages or a user selection of individual pages of the scanned document.

8. The multifunction peripheral of claim 1 wherein the scanned document with the barcode is output to one or more of a print engine of the multifunction peripheral, or a user via a network associated with the multifunction peripheral.

9. A method of adding a barcode to a scanned document on a multifunction peripheral comprising:
scanning a physical document comprised of an information record associated with an identified person into a scanned document on a multifunction peripheral;
displaying a preview of the scanned document;
receiving user commands associated with barcode data for the scanned document on a user interface of the multifunction peripheral, wherein the user commands include a user selection of a selected area on a displayed preview of the scanned document corresponding to an identity of the person;
determining barcode data based at least in part on the user commands;
generating a barcode identifying the person from the barcode data;
positioning the barcode onto the scanned document, and
outputting the scanned document with the barcode.

10. The method of claim 9 wherein receiving user commands comprises receiving a user entry of one or more alphanumeric characters via the user interface, and wherein the barcode data includes the alphanumeric characters.

11. The method of claim 9 wherein receiving user commands comprises receiving, via the user interface, a user selection of a selected area of the preview of the scanned document, and wherein determining barcode data comprises performing optical character recognition of one or more alphanumeric characters in the selected area.

12. The method of claim 9 further comprising:
generating a preview of the scanned document with the barcode; and
displaying, via the display, the preview of the scanned document with the barcode.

13. The method of claim 12 further comprising:
receiving, via the user interface, user commands associated with positioning the barcode on the scanned document; and
positioning the barcode onto the scanned document based at least in part on the user commands associated with positioning the barcode.

14. The method of claim 13 wherein the user commands include entry of at least one x,y coordinate pair.

15. The method of claim 13 wherein the user commands include a page input selected from the group consisting of all pages only even pages only odd pages, or a user selection of individual pages of the scanned document.

16. The method of claim 9 wherein outputting includes one or more of printing the scanned document with the barcode, or forwarding the document with the barcode to a user via a network associated with the multifunction peripheral.

17. A document processing device comprising:
a scan engine configured to scan a tangible document comprised of an information record associated with an identified person into an electronic document;
a display configured to display the electronic document;
a memory configured to store one or more of
the electronic document,
a default barcode position;
a processor configured to
generate a barcode,
generate a preview of the electronic document that includes the barcode at the default barcode position, and
generate a barcoded electronic document;
a print engine configured to print the barcoded electronic document;
a network interface configured to send the barcoded electronic document; and
an input configured to accept a selection of an area of the electronic document corresponding to an identity of the person,
wherein the processor is further configured to perform optical character recognition in the selected area, and
wherein the barcode is generated to identify the person from optically recognized characters.

18. The document processing device of claim 17 further comprising:
an input configured to accept a selection of an area of the electronic document,
wherein the processor is further configured to perform optical character recognition in the selected area, and
wherein the barcode generated from optically recognized characters.

19. The document processing device of claim 17 further comprising:
an input configured to accept a document identifier,
wherein the barcode is generated from the document identifier.

20. The document processing device of claim 17 further comprising:
an input configured to accept a user selected position indication for placement of the barcode onto the electronic document, and
wherein the processor generates the barcoded electronic document with the barcode positioned in accordance with the user selected position indication.
